(19) United States
(12) Patent Application Publication
(10) Pub. No.: US 2007/0204323 A1
(43) Pub. Date: Aug. 30, 2007

(54) Auto-detection capabilities for out of the box experience

(75) Inventors: John Wilkinson, Hudson, OH (US); Brian A. Batke, Novelty, OH (US); Kenwood H. Hall, Hudson, OH (US); Taryl J. Jasper, South Euclid, OH (US); Michael D. Kalan, Highland Heights, OH (US); James B. Vitrano, South Milwaukee, WI (US); Jeffrey A. Shearer, North Royalton, OH (US)

Correspondence Address: ROCKWELL AUTOMATION, INC./(AT), ATTENTION: SUSAN M. DONAHUE, E-7F19, 1201 SOUTH SECOND STREET, MILWAUKEE, WI, 53204, US

(73) Assignee: Rockwell Automation Technologies, Inc., Mayfield Heights, OH (US)

(21) Appl. No.: 11/361,606

(22) Filed: Feb. 24, 2006

(51) Int. Cl. H04L 9/00

(52) U.S. Cl. 726/1

(57) ABSTRACT

Various embodiments are described in connection with auto-detection capabilities of a device in an industrial environment. The device can behave differently in a secured environment than it would in an unsecured environment. If in a secured environment, the device can obtain an auto configuration policy to control the device's security configuration from a security authority, for example. The device can configure itself based on the policy. Both secured-by-default and open-by-default can be supported based on the environment. According to some embodiments, needed security domain specific knowledge can be reduced, which increases the number of maintenance personnel that can add or replace a device in a secured system.

### TECHNICAL FIELD

The following description relates generally to industrial systems, and more specifically to security auto-detection capabilities in an industrial environment.

### BACKGROUND

Advances in computing technology allow businesses to operate more efficiently when compared to substantially similar businesses only a few years ago. For example, internal networking enables employees of a company to communicate instantaneously by email, quickly transfer data files to disparate employees, manipulate data files, share data relevant to a project to reduce duplications in work product, etc. Technology advancements have also enabled factory applications to become partially or completely automated. For example, operations that once required workers to put themselves proximate to heavy machinery and other various hazardous conditions can now be completed at a safe distance.

Such technological advancements have brought about the need to provide security to prevent access that is unauthorized or undesired, regardless of whether such access is malicious or benign. In security environments, “secure-by-default” is rapidly becoming the standard. Users that are concerned with security desire the maximum amount of security gaps closed in the automation space.

Some basic approaches have been to either ignore security by leaving the device completely open until it is configured or to require the device to be bench loaded with the security configuration. Bench loaded refers to security configuration in a non-secure standalone environment. If security is not easy to maintain, entropy can drive undesirable user behaviors. For example, a user may not properly configure a device or may not configure the device at all. Thus, although the device has been installed in a secured environment, it may not be taking advantage of the security features available.

To overcome the aforementioned as well as other deficiencies, what is needed is a mechanism for a device to automatically detect whether it is in a secured environment and take appropriate action(s). What is also needed is a device that behaves in a secured manner when introduced into a secured environment and behaves in an unsecured manner in an unsecured environment.

### SUMMARY

The following presents a simplified summary of one or more embodiments in order to provide a basic understanding of some aspects of such embodiments. This summary is not an extensive overview of the one or more embodiments, and is intended to neither identify key or critical elements of the embodiments nor delineate the scope of such embodiments. Its sole purpose is to present some concepts of the described embodiments in a simplified form as a prelude to the more detailed description that is presented later.

In accordance with one or more embodiments and corresponding disclosure thereof, various aspects are described in connection with auto-detection capabilities of a device in an industrial environment. The device can behave differently in a secured environment than it would in an unsecured environment. If in a secured environment, the device can obtain an auto configuration policy to control the device's security configuration from a security authority, for example. The device can configure itself based on the policy. Both secured-by-default and open-by-default can be supported based on the environment.

According to some embodiments, the disclosed techniques can reduce the complexity involved in adding or replacing devices in a secured system, provide faster device replacement and increase production uptime. Business complexity can also be reduced by allowing a single device to behave as either a secured device or an unsecured device. According to further embodiments, needed security domain specific knowledge can be reduced, which increases the number of maintenance personnel that can add or replace a device in a secured system.

According to an embodiment is a system that automatically detects an environment type. The system includes an analysis component that analyzes an environment of an industrial device, a policy component that obtains a policy, and a configuration component that configures the industrial device based in part on the obtained policy. According to some embodiments, the system can include a search module that searches for neighboring or proximate devices and a query module that requests information from the neighboring devices that can be utilized to contact the security authority. The system can support one of a secured-by-default mode and an open-by default mode based in part on the environment.

According to another embodiment is a method for environment detection and industrial device configuration. The method includes searching for policies internal to an industrial device and analyzing an external environment to determine if the industrial device is located in a secured environment or an unsecured environment. The method can also include applying an appropriate security action based in part on the external environment.

To the accomplishment of the foregoing and related ends, one or more embodiments comprise the features hereinafter fully described and particularly pointed out in the claims. The following description and the annexed drawings set forth in detail certain illustrative aspects and are indicative of but a few of the various ways in which the principles of the embodiments may be employed. Other advantages and novel features will become apparent from the following detailed description when considered in conjunction with the drawings and the disclosed embodiments are intended to include all such aspects and their equivalents.

### BRIEF DESCRIPTION OF THE DRAWINGS

FIG. 1 illustrates a system for automatically detecting the presence of a security authority.

FIG. 2 illustrates another system for automatically detecting the presence of a security authority.

FIG. 3 illustrates a system for detecting whether a device is in a secured or an unsecured environment.

FIG. 4 illustrates a system for taking appropriate action depending on whether a device is in a secured or an unsecured environment.

FIG. 5 illustrates a system for configuring device behavior based on a security environment.

FIG. 6 illustrates another system for automatically detecting the presence of a secured environment.

FIG. 7 illustrates a system that employs artificial intelligence for automating one or more features in accordance with the various embodiments disclosed herein.

FIG. 8 illustrates a system that employs a rules-based logic component in accordance with the various embodiments presented herein.

FIG. 9 illustrates a methodology for automatically detecting the presence or absence of a secured environment.

FIG. 10 illustrates a methodology for automatically configuring a device located in a secured environment.

FIG. 11 illustrates a methodology for determining whether to enter a discovery mode.

FIG. 12 illustrates a methodology for configuring a device located in a secured environment.

FIG. 13 illustrates a methodology for determining whether to behave in a secured or an unsecured manner.

FIG. 14 illustrates a block diagram of a computer operable to execute the disclosed embodiments.

FIG. 15 illustrates a schematic block diagram of an exemplary computing environment operable to execute the disclosed embodiments.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more aspects. It may be evident, however, that the various embodiments may be practiced without these specific details. In other instances, well-known structures and devices are shown in block diagram form in order to facilitate describing these embodiments.

As used in this application, the terms “component, “module,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Furthermore, the one or more embodiments may be implemented as a method, apparatus, or article of manufacture using standard programming and/or engineering techniques to produce software, firmware, hardware, or any combination thereof to control a computer to implement the disclosed embodiments. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the disclosed embodiments.

Artificial intelligence based systems (e.g., explicitly and/or implicitly trained classifiers) can be employed in connection with performing inference and/or probabilistic determinations and/or statistical-based determinations as in accordance with one or more aspects as described hereinafter. As used herein, the term “inference” refers generally to the process of reasoning about or inferring states of the system, environment, and/or user from a set of observations as captured through events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject embodiments.

Various embodiments will be presented in terms of systems that may include a number of components, modules, and the like. It is to be understood and appreciated that the various systems may include additional components, modules, etc. and/or may not include all of the components, module etc. discussed in connection with the figures. A combination of these approaches may also be used.

In this detailed description, various aspects and embodiments may be described in the context of an industrial controller. While the disclosed embodiments may be well suited for use with an industrial controller, those skilled in the art will readily appreciate that these inventive aspects are likewise applicable for use with various other devices that can be placed in a secured environment. Accordingly, any reference to an industrial controller is intended only to illustrate the inventive aspects, with the understanding that such inventive aspects have a wide range of applications.

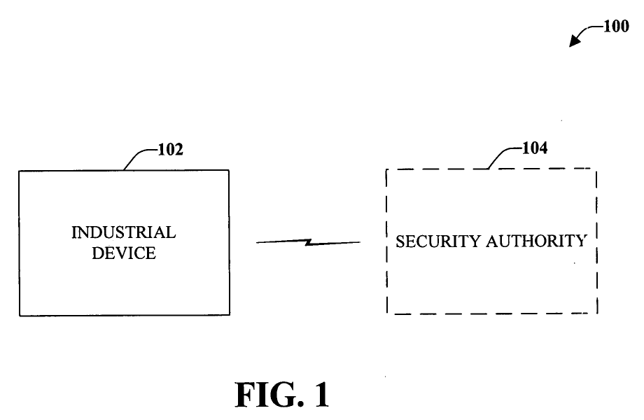

Referring initially to FIG. 1, illustrated is a system 100 for automatically detecting the presence of a security authority. System 100 includes an industrial device 102 that can interface with a security authority 104. The interface between the industrial device 102 and the security authority 104 can be through a wireless link, as illustrated, or through a wired link. It should be understood that while system 100 can include more than one industrial device 102 and one security authority, only one is illustrated for simplicity purposes. According to some embodiments, a security authority is not present in system (e.g., unsecured environment), therefore, security authority 104 is illustrated by dotted lines.

Industrial device 102 can be a special-purpose computer or industrial controller utilized for controlling industrial processes, manufacturing equipment, and other factory automation processes, such as data collection through networked systems. Controllers often work in concert with other computer systems to form an environment whereby a majority of modern and automated manufacturing operations occur. These operations involve front-end processing of materials such as steel production to more intricate manufacturing processes such as automobile production that involves assembly of previously processed materials. Often such as in the case of automobiles, complex assemblies can be manufactured with high technology robotics assisting the industrial control process. It should be understood that the disclosed techniques can be implemented through a variety of devices in an industrial system, such as controllers, Human Machine Interfaces (HMIs), and the like.

Industrial device 102 can be configured to automatically seek security authority 104 periodically or continuously. For example, device 102 can search for security authority 104 upon power up, periodically at a particular interval (e.g., every 5 seconds, every minute, . . . ), at a user's request, or based on other criteria (e.g., new installation, initial configuration, . . . ).

If a security authority 104 is detected, it can indicate device 102 is in a secured environment, and appropriate action can be taken. Such action includes limiting the capabilities of industrial device 102, configuring device 102 based on a policy authorized by security authority 104, or other actions relating to the secured environment, device 102, and/or security authority 104. According to some embodiments, the environment may be secured but the security authority is currently missing. In accordance with some embodiments, there is no security authority 104 but device 102 is in a secured environment, therefore, device 102 can behave as a secured device based on information received from proximate devices and/or internally programmed policies. In some embodiments, if an unsecured environment is detected, industrial device 102 can apply the internal security policies and can conform its communication to such internal policies. According to some embodiments, the internal policies can be applied to other devices within the system.

If a security authority 104 is not detected, it can indicate that the industrial device 102 is not in a secured environment. It should be noted that in accordance with some embodiments, security authority 104 exists, but its policy setting might be for device 102 to behave as though in an unsecured state. When installed in such an unsecured environment, there may be no security specification policies enforced.

In some embodiments, for simple devices (e.g., input/output (I/O) modules, a module with only one communication interface, . . . ), a proxy or bridge module can provide the functionality for the simple device. The bridge module can detect the presence of an unsecured or out-of-box module (e.g., I/O module) and contact the security authority on behalf of the simple module. The bridge module can perform other functions for the simple module relating the secured and/or unsecured environment. Thus, the simple module can be provided a security configuration that conforms to the environment in which the simple module is inserted.

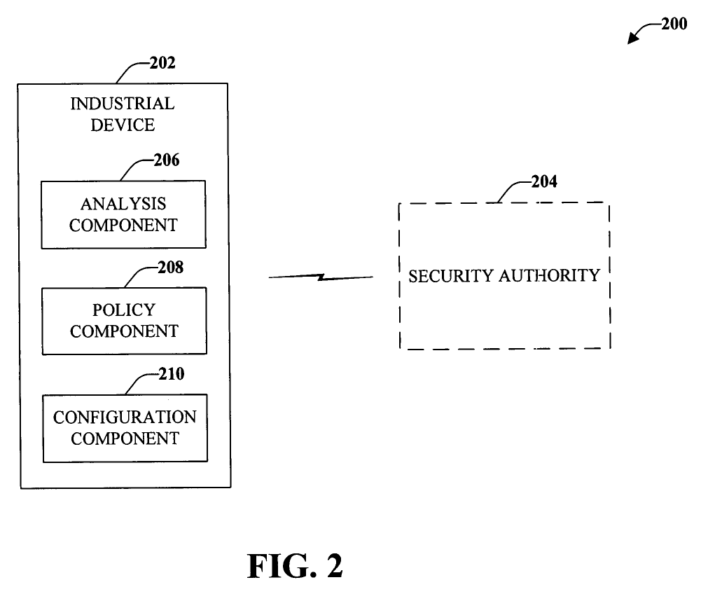

FIG. 2 illustrates another system 200 for automatically detecting the presence of a security authority. System 200 includes an industrial device 202 and a security authority 204. It should be understood that while a security authority 204 is illustrated, system 200 might not have a security authority 204 indicating that industrial device 202 may be installed in an unsecured environment.

Industrial device 202 can include an analysis component 206, a policy component 208, and/or a configuration component 210. Analysis component 206 can be configured to search for internal policy information. This internal information can include information already obtained from a security authority, proximate device(s), or another sources and stored internally in the device.

If no internal information is found, a discovery mode can automatically be entered to ascertain if the device is in a secured or an unsecured environment. If in an unsecured environment, the device behaves as an unsecured device in an open-by-default mode. According to some embodiments, device can have its own internal policies directing how it should behave based on, for example, business rules for that particular device (e.g., wide open, download enabled, . . . ).

If a security authority 204 is found, policy information can be requested from security authority 204. In some embodiments, security authority 204 can periodically or continuously broadcast policy information. The policy information can be incorporated into the functionalities of industrial device 202. For example, the capabilities of industrial device 202 can be limited in a secured environment.

Policy component 208 can be configured to obtain an automatic configuration policy from various sources, including security authority 204, internal storage, and/or a device within the proximity of industrial device 102. The configuration policy can govern a security configuration of industrial device 202 and can be enforced by configuration component 210. Thus, industrial device 202 can configure itself based on the policy received or obtained policy. In the absence of security authority 204, industrial device 202 can function in an unsecured mode or it can configure policies or rules stored internally (or in a retrievable format) in industrial device 202.

Policy component 208 can, in addition or alternatively, obtain policy information from a proximate device that has information regarding the security policies of industrial device 202. For example, industrial device 202 may send or transmit a copy or duplicate of its security policies to a proximate device for later retrieval purposes, such as if industrial device 202 becomes unable to access its own internally stored security policies. The duplicate security policies can be communicated from the proximate device and applied to industrial device 202. Security authority 204, if in system 200, can be contacted for one or more updates to the duplicate security policy or policies.

If industrial device 202 is in a secured environment, but policy component 208 is unable to obtain a policy, configuration component 210 can configure device 202 based on a built in security policies or behavior. This built in or programmed security policy can be optionally provided device specific behavior built into the device, for example, during initial device configuration. Policy component 208 may not be able to obtain a policy if there is no security server and/or no neighboring or proximate devices cannot supply security related information, for example. However, if the device is in a secured environment, policy information that was previously programmed into device 202 and stored in an associated storage medium can be applied to the device in the secured environment. Such programmed information can include common security parameters, policies based on business rules associated with similar devices, and the like.

For example, when industrial device 202 is initially placed in an industrial environment (or at any time), analysis component 206 can first search internally for saved or retrievable information relating to security policies and/or procedures previously received. If internal information is found, the policies and/or procedures can be applied to the device. If it is in a secured environment, it can attempt to obtain policy information from a detected security authority or another source. The device can gainer the information needed from that security authority and/or other source and behave or conform according to the received policy information.

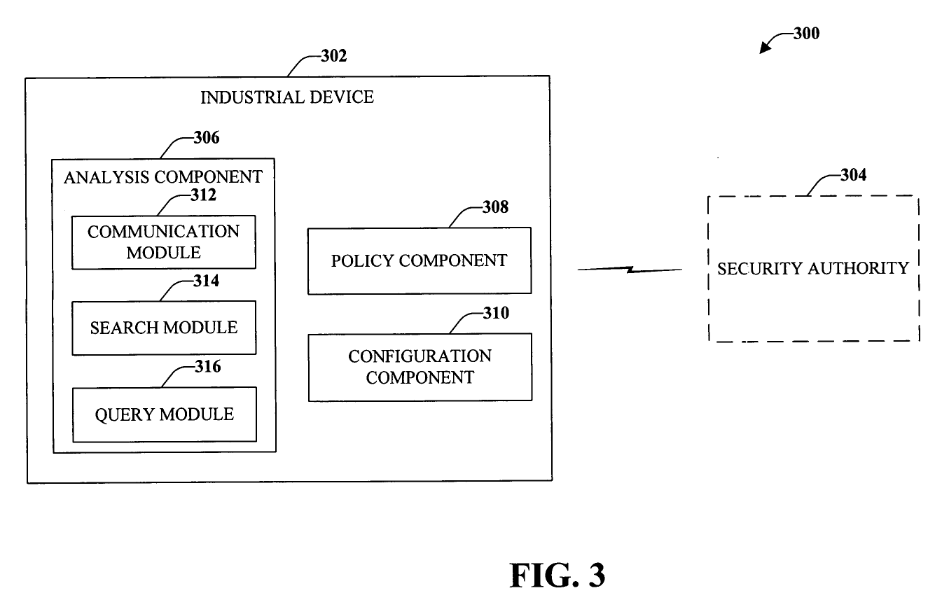

FIG. 3 illustrates a system 300 for detecting whether a device is in a secured or an unsecured environment. System 300 includes an industrial device 302 and a security authority 304. It should be understood that security authority 304 is optional and, according to some embodiments, is not included in system 300 even if the environment is secured. Industrial device 302 can include an analysis component 306 that analyzes an environment, a policy component 308 that can obtain or receive at least one policy, and a configuration component 310 that configures the device 302 to conform to an internal and/or an external policy (e.g., from security authority, from another device, manual configuration).

Analysis component 306 can include a communication module 312, a search module 314 and a query module 316. When industrial device 302 powers up, for example, it can search internally for saved security information, through, for example, search module 314. If security information is found, it can be applied to the functionalities of industrial device 302. If no security information is found, a discovery mode can be entered to search for external security information. According to some embodiments, a discovery mode is entered even if internal security information is found. Such a discovery mode can be entered to obtain any modifications to an internal policy (e.g., additions, deletions, modifications, . . . ). A discovery mode can also be entered to search within the environment for other devices that may have security information or to find devices that are searching for security information. The contact with security authority 304 or other devices can be performed by communication module 312.

Search module 314 can be configured to locate proximate devices within the local environment. These proximate devices can be devices located near or proximate to industrial device 302 or they may be devices connected to industrial device 302. For example, a proximate device can be a slot on the industrial device 302 backplane, MAC address on ControlNet, fixed name lookup, EtherNet/IP (e.g., Subnet, Multicast), or other devices.

The proximate devices can be queried (e.g., sequentially, randomly, . . . ) for information by query module 316 until a security object, security information, device configuration and/or other information the device may be hosting for the querying device, is discovered or received from one or more device. Query module 316 can request security information such as security server identification, a path to the security server, or other pertinent security information that the proximate device may have and which can be utilized to contact the security authority. The information can include the proximate device's configuration or other information.

The information from the proximate devices can be utilized to contact security authority 304 and policy component 308 can determine the appropriateness of security information received from security authority 304 for the particular industrial device 302. Configuration component 310 can configure industrial device 302 according to the policy information received from security authority 304. The configuration component 310 can perform the configuration autonomously or after a user has been prompted to accept or deny the configuration. By configuring according to information from security authority 304, industrial device 302 can conform to the rules or policies of the secured environment in which it is located.

According to some embodiments disclosed herein, automatic configuration is not limited to security. For example, if a recently inserted device has no knowledge of security (e.g., is an unsecured device) automatic device replacement can be accomplished with the disclosed techniques. For example, the information relating to a controller may be stored on a communication card, another controller, or another device (e.g., piece of equipment). If the recently inserted device is connected to the system for the first time (either as a replacement for the first controller or as a second unit), it can request information from other devices in the system to ascertain how it should behave. The device (e.g., communication card, another controller, or another device) that has the configuration for the controller can automatically provide the information to the recently inserted device. The information can include security features, however, in some situations, security is not included with the provided information.

According to some embodiments, product specific device hardening may be initiated by the disclosed techniques, such as through configuration component 310. Device hardening refers to the concept that some aspect or capability is prohibited or restricted in both a secured and an unsecured environment. Thus, the device will perform the same for certain functions regardless of the environment (e.g., secured, unsecured, partially secured) in which it is located. The disclosed techniques can be extensible to software on a white box in accordance with some embodiments.

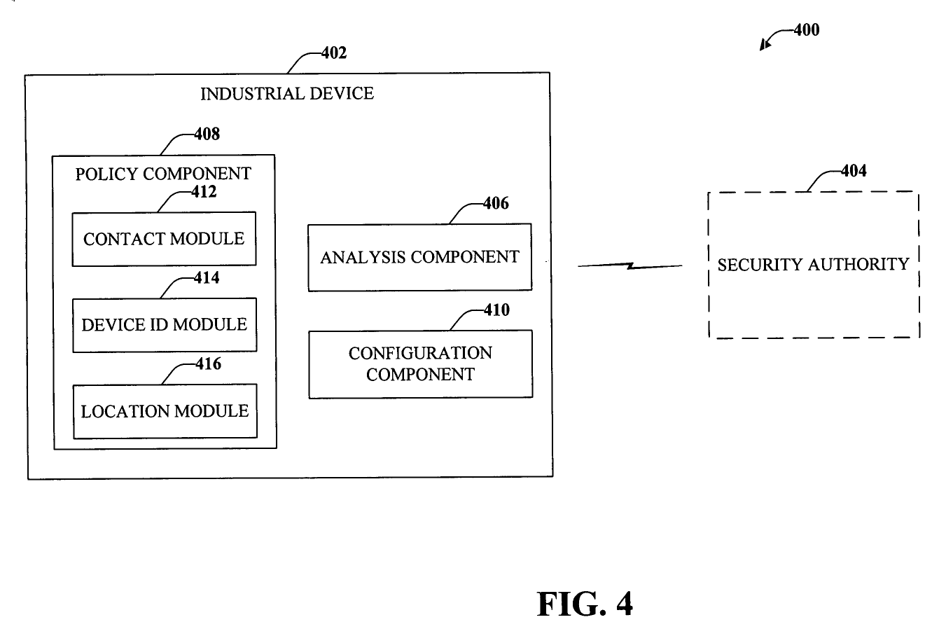

FIG. 4 illustrates a system 400 for taking appropriate action depending on whether a device is in a secured or an unsecured environment. System 400 includes at least one industrial device 402 and, according to some embodiments, a security authority 404. It should be understood that a security authority 404 may not be included in system 400 regardless of whether industrial device 402 is located or installed in a secured or an unsecured environment. Industrial device 402 can include an analysis component 406 that analyzes an environment, a policy component 408 that obtains environment policy information, and a configuration component 410 that configures industrial device 402 in conformance with the environment policy.

Policy component 408 can include a contact module 412 that can be configured to contact detected security authority 404 in order to obtain environment security information. A device identification (id) module 414 can be configured to send device (e.g., industrial controller) identity information to security authority 404. Device identity information can include the type of device, configuration of device, and other information that can be utilized by security authority 404 to identify device.

Also included in policy component 408 can be a location module 416 that can be configured to provide a location to the security authority 404. The location can be a URL with an IP address or domain name, for example. In some embodiments, it may be a CIP path, which can be a true path that specifies instructions on how to reach security authority 404 from a specific device. For example, a network path can include location information of device, intermediary devices that should be contacted to obtain access to device (if direct access to device is not available) and other information that can be utilized by security authority 404 to establish and maintain communication with industrial device 402. It should be understood that there can be other ways to identify location and a path data is just one example.

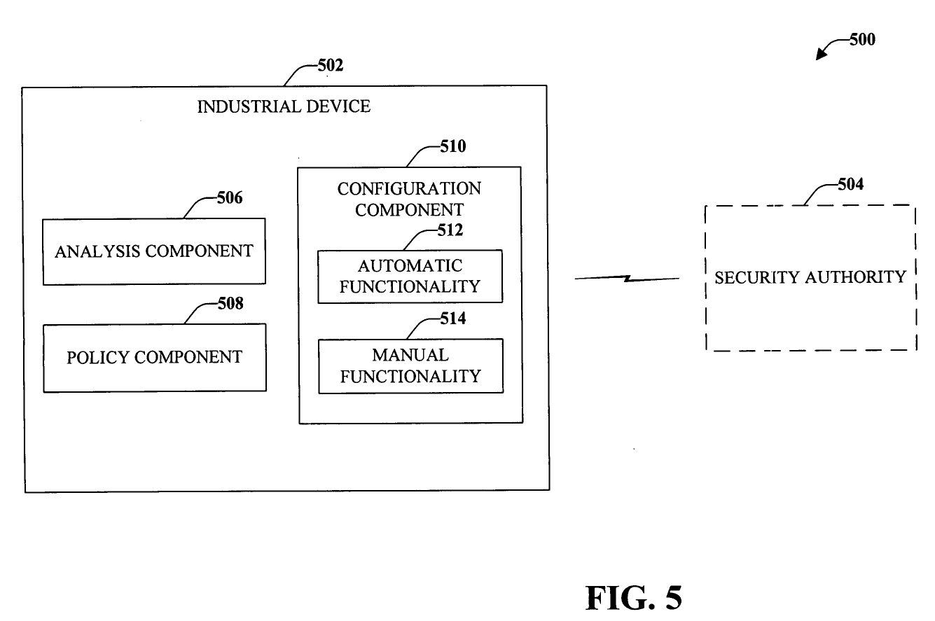

FIG. 5 illustrates a system 500 for configuring device behavior based on a security environment. System 500 includes an industrial device 502 that communicates through a wired link or through a wireless link with a security authority 504. Industrial device 502 can include an analysis component 506 and a policy component 508. Industrial device 502 can also include a configuration component 510 that includes automatic functionality 512 and/or manual functionality 514.

Automatic functionality 512 can be configured to automatically apply, configure, restore, delete, etc. security rules, policies, or other criteria received from security authority 504. With automatic functionality 512, a user can move a device into a new environment (e.g., from unsecured to secured or from unsecured to unsecured) and appropriate security parameters can be automatically configured for the device. According to some embodiments, automatic functionality 512 can be the default mode for the device.

Manual functionality 514 allows a user and/or entity (e.g., another device, another system, a computer, . . . ) to manually apply, change, and/or delete security parameters of the industrial device 502. Examples of manual configuration can include, but are not limited to, not accepting anything but a local download or allowing industrial device 502 to be loaded remotely.

Automatic functionality 512 and manual functionality 514 can be utilized in conjunction. For example, the device can be initially configured utilizing automatic functionality 512 and a user and/or entity can selectively modify one or more parameter (that was automatically configured) by accessing the manual functionality 514.

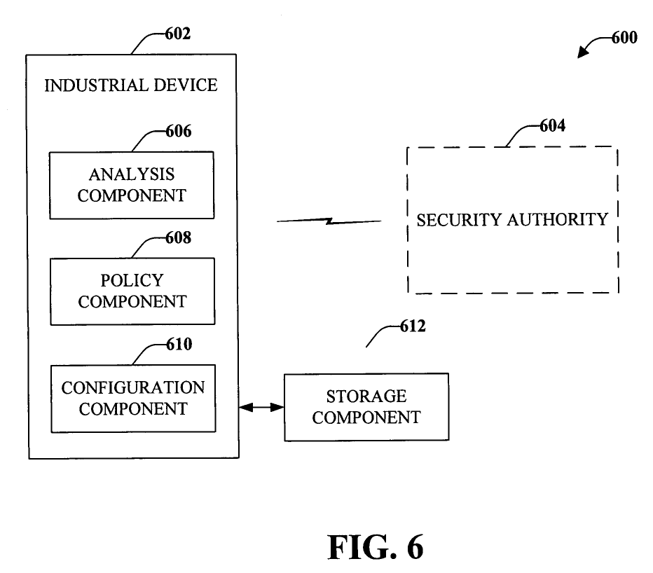

FIG. 6 illustrates another system 600 for automatically detecting the presence of a secured environment. System 600 is similar to the systems described with reference to the above figures. An industrial device 602 includes an analysis component 606, a policy component 608, and a configuration component 610. Analysis component 606 can be configured to search for internal policy information that can be contained in a storage component 612. Storage component 612 can maintain the information in a retrievable format that can be searched upon request or automatically. The programmed information can include common security parameters, policies based on business rules associated with similar devices, etc.

By way of example and not limitation, storage component 612 can include nonvolatile and/or volatile memory. Suitable nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

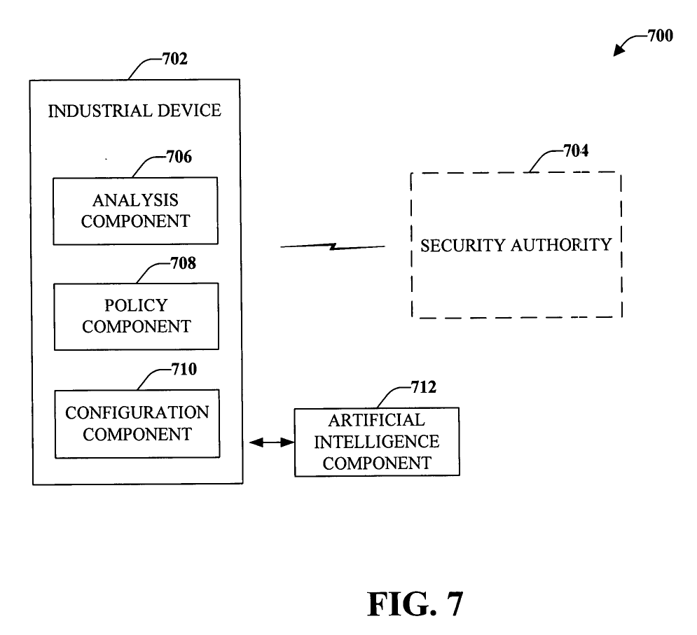

FIG. 7 illustrates a system 700 that employs artificial intelligence (Al) which facilitates automating one or more features in accordance with the various embodiments disclosed herein. System 700 includes an industrial device 702 and a security authority 704. System 700 is similar to the systems described with reference to the above figures. Artificial intelligence can be effected through artificial intelligence component 712 as illustrated.

The various embodiments (e.g., in connection with automatically detecting whether in a secured or an unsecured environment) can employ various Al-based schemes for carrying out various aspects thereof. For example, a process for determining if a particular device is located or installed in a particular type of environment and, if in a secured environment, the security policies that should be enabled for the device through an automatic classifier system and process.

A classifier is a function that maps an input attribute vector, x=(x1, x2, x3, x4, xn), to a confidence that the input belongs to a class, that is, f(x)=confidence (class). Such classification can employ a probabilistic and/or statistical-based analysis (e.g., factoring into the analysis utilities and costs) to prognose or infer an action that a user desires to be automatically performed. In the case of a secured environment, for example, attributes can be an internal security policy or an external security policy and the classes are categories or areas of interest (e.g., functions available).

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical, to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the one or more embodiments can employ classifiers that are explicitly trained (e.g., through a generic training data) as well as implicitly trained (e.g., by observing user behavior, receiving extrinsic information). For example, SVM's are configured by a learning or training phase within a classifier constructor and feature selection module. Thus, the classifier(s) can be used to automatically learn and perform a number of functions, including but not limited to determining according to a predetermined criteria when to grant access, which stored procedure to execute, etc. The criteria can include, but is not limited to, the amount of data or resources to access through a call, the type of data, the importance of the data, etc.

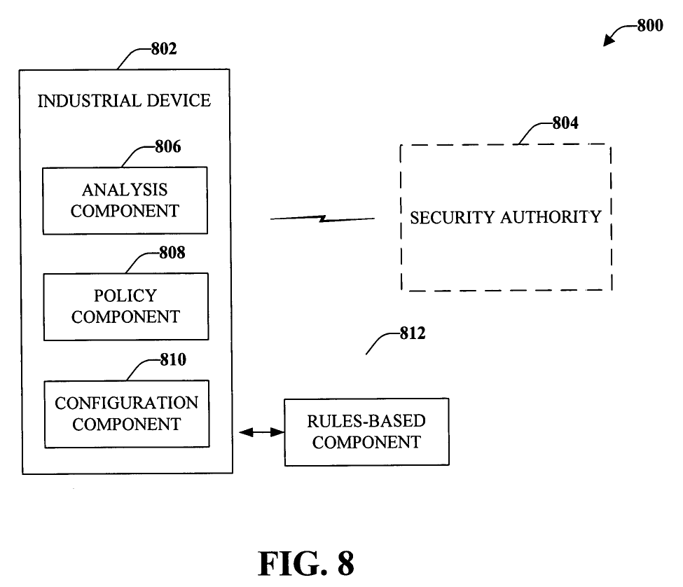

With reference now to FIG. 8, illustrated is a system 800 that employs a rules-based logic component in accordance with the various embodiments presented herein. System 800 includes an industrial device 802 that interfaces with a security authority 804. Industrial controller can include an analysis component 806, a policy component 808, and/or a configuration component 810. Also included in system can be a rules-based component 812.

In accordance with this alternate aspect, an implementation scheme (e.g., rule) can be applied to control and/or regulate policies associated with industrial device 802 that is located or installed in a secured environment. It will be appreciated that the rules-based implementation can automatically and/or dynamically detect the presence or absence of as secured environment and associated policies of industrial device 802 based upon a predefined criterion. In response thereto, the rules-based implementation can automatically tailor the industrial device 802 to the environment by employing a predefined and/or programmed rule(s) based upon any desired criteria (e.g., data type, data size, data importance, database owner, caller identity . . . ).

By way of example, a user can establish a rule that can require a trustworthy flag and/or certificate to access a predefined type of resource whereas, other resources within a particular environment may not require such security credentials. It is to be appreciated that any preference can be effected through pre-defined or pre-programmed in the form of a rule. It is to be appreciated that the rules-based logic described with reference to FIG. 8 can be employed in addition to or in place of the Al-based components described with reference to FIG. 7.

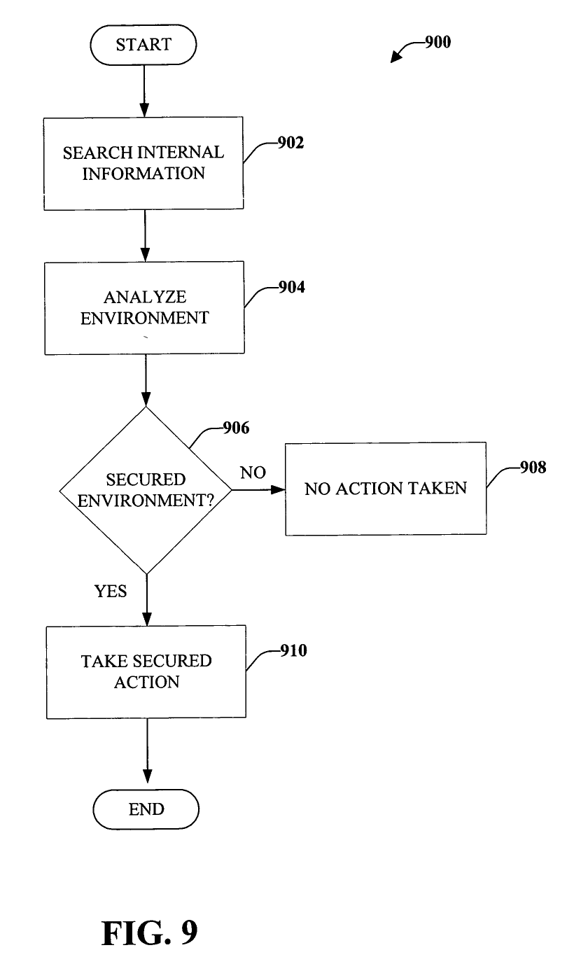

In view of the exemplary systems shown and described above, methodologies, which may be implemented in accordance with one or more aspects of the various embodiments, will be better appreciated with reference to the diagram of FIGS. 9-13. While, for purposes of simplicity of explanation, the methodologies are shown and described as a series of acts (or function blocks), it is to be understood and appreciated that the methodologies are not limited by the order of acts, as some acts may, in accordance with these methodologies, occur in different orders and/or concurrently with other acts from that shown and described herein. Moreover, not all illustrated acts may be required to implement a methodology in accordance with one or more aspects of the disclosed embodiments. It is to be appreciated that the various acts may be implemented by software, hardware, a combination thereof or any other suitable means (e.g. device, system, process, component) for carrying out the functionality associated with the acts. It is also to be appreciated that the acts are merely to illustrate certain aspects presented herein in a simplified form and that these aspects may be illustrated by a lesser and/or greater number of acts. Moreover, not all illustrated acts may be required to implement the following methodologies. Those skilled in the art will understand and appreciate that a methodology could alternatively be represented as a series of interrelated states or events, such as in a state diagram.

Referring now to FIG. 9 illustrated is a methodology 900 for automatically detecting the presence or absence of a secured environment. At 902, an internal search is conducted for security information upon device power up, during initial configuration, etc. This information can be device specific depending, for example, on the type of device, or it can be common industrial protocols that should be observed in the presence or absence of a secured environment.

After internal information is found and/or if there was no internal information found, an environment of the device is analyzed, at 904. A determination is made, at 906, whether the environment is a secured environment or a non-secured environment (e.g., there is no security authority and/or no security policy in force). If the determination at 906 is that it is not a secured environment (“NO”), the method 900 continues at 908 and no secured action is taken. However, according to some embodiments, if internal security information was found at 902, this information can be applied in an unsecured environment.

If it is determined at 906 that there is a secured environment (“YES”), secured action is taken at 910. In some embodiments, the secured action can be based on information received from a security authority or other devices. The security authority can provide a policy based on, for example, a device class, type, model, etc., thus limiting what functions can be performed on that particular device. According to some embodiments, the secured action can be following a built in security behavior. The security authority can vary a policy based on various device attributes including the physical or network location of the device. In accordance with some embodiments, even though a security authority may not be present, it is a secured environment and, therefore, the device behaves in a secured manner.

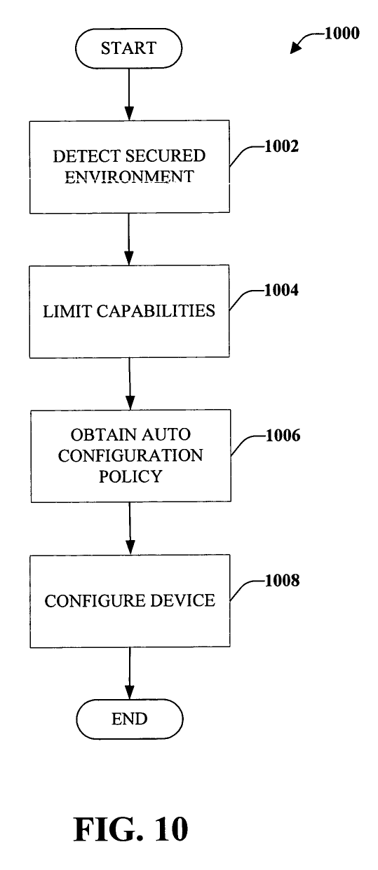

FIG. 10 illustrates a methodology 1000 for automatically configuring a device located in a secured environment. The method 1000 begins, at 1002, when a secured environment is detected. Such detection can occur when a device is installed in an environment, at power up, etc. At 1004, a capacity of a device is limited based in part on information from a security authority located in the secured environment. Examples of such limitation can include, but are not limited to, only accepting security configuration information, accepting security configuration information or local download, the device should be physically connected to another device in order to interact with that device, etc.

At 1006, a security automatic configuration policy is obtained. This information can be obtained from a security server, if one is present in the environment. If there is no security server or authority present, the security information can be obtained from for example, internal storage of a cached policy, a proximate device that hosts the policy information, and/or rules programmed internally. A security automatic configuration policy can support automatic configuration, which might be a default mode, or a manual configuration, or both. At 1008, the device is configured by the automatic configuration or the manual configuration, depending on the parameters associated with the device and/or the environment. If the device is in a secured environment, but no policy was obtained, at 1006, the device should follow a built in security behavior, if one exists.

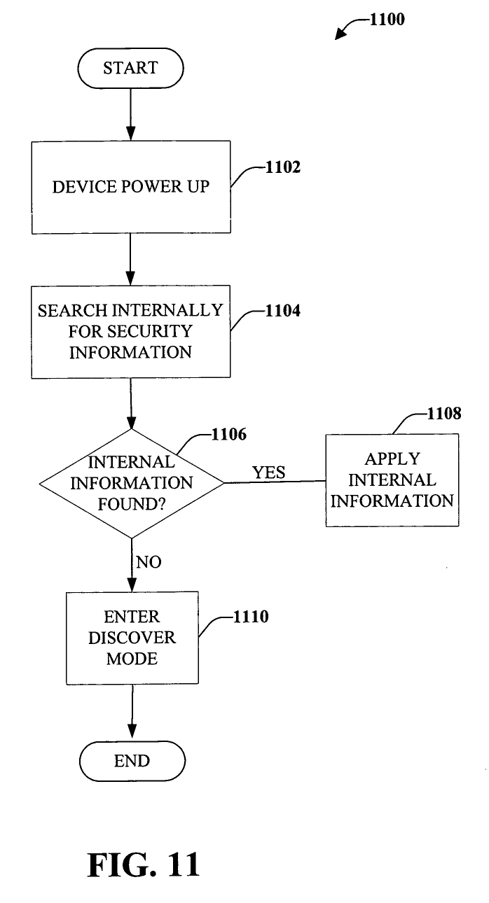

FIG. 11 illustrates a methodology 1100 for determining whether to enter a discovery mode. The device powers up, at 1102. The device can be an industrial controller or any other device utilized in an industrial environment. At substantially the same time as power up, an internal search is conducted, at 1104, to find security information. This internal security information can be information already programmed in a device manually by a user or information previously obtained from a security authority (if the device is in, or was in, a secured environment), or information obtained from a proximate device. The internal security information can be included in a cached policy stored in the device.

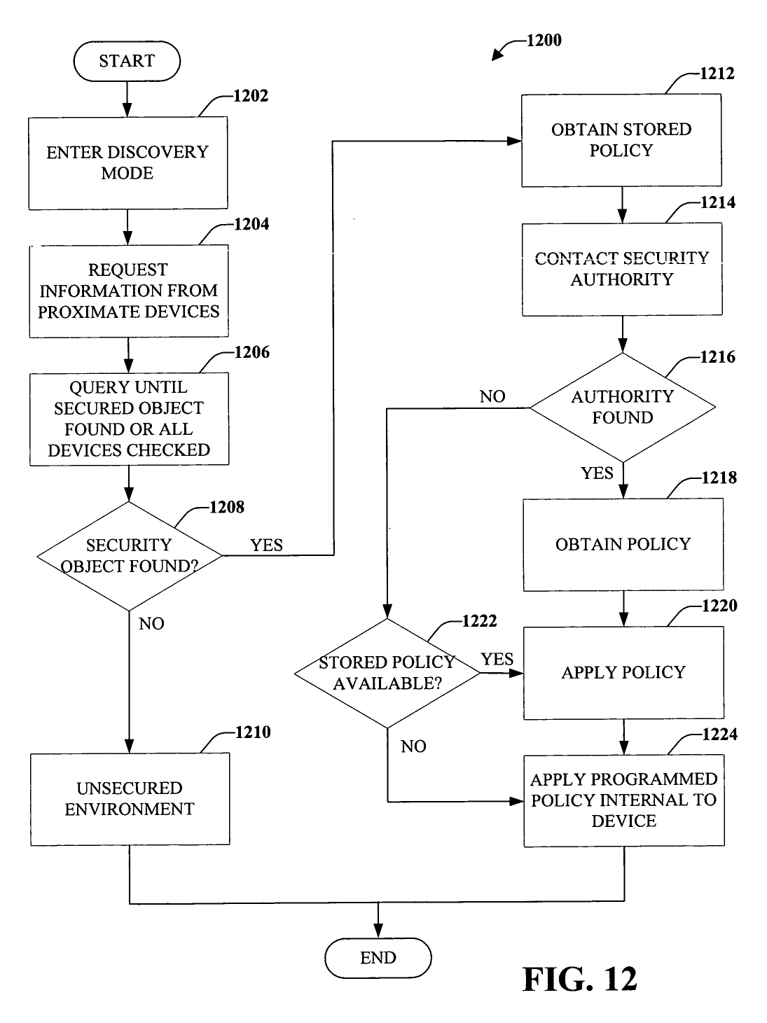

At 1106, a determination is made whether internal security information is found. If there is internal information found (“yes”), the internal information is applied, at 1108. This internal information can be information previously received from various devices (e.g., security authority, proximate devices, and the like) and stored internally in the device. If there is no internal information found, a discover mode is entered, at 1110. The discover mode is discussed with reference to FIG. 12 that illustrates a methodology 1200 for configuring a device located in a secured environment.

The method 1200 begins at 1202, when discovery mode is entered by an industrial device. At 1204, a request for information from proximate devices is sent. The proximate devices can be any device, component, and the like connected to any of the industrial device's ports (e.g., slot on backplane, MAC address on ControlNet, fixed name lookup, EhterNet/IP (subnet, multicast), and the like). Each proximate device can be queried (e.g., sequentially), at 1206, until a security object is discovered or until each proximate device is checked for security object information.

For example, the industrial device can ask its proximate device(s) for security information. Such information can include a security server identification and/or a location or path to the security server. For example, the location may be a URL with an IP address or domain name, or it may be a CIP path specifying instructions for reaching the security authority from this specific device. The information can also include other pertinent security information that the proximate device may have and can include the proximate device's configuration. In accordance with some embodiments, proximate device can store a duplicate or copy of the policies of the industrial device. These duplicate policies can be obtained by the industrial device if such device cannot retrieve its own policies.

At 1208, a determination is made whether a security object is found. If a security object is not found (“NO”), the method 1200 continues, at 1210, where the device, located in an unsecured environment, acts in an unsecured manner. In accordance with some embodiments, the security authority exists, but its current policy setting is for the device to behave as though it is in an unsecured state. For example, the device may ignore its built-in security behaviors, if any, and behave in an unsecured fashion.

If the determination at 1208 is that a security object is found (“YES”), a stored policy is obtained, at 1212, if such a stored policy exists. The method 1200 continues, at 1214, where the security authority can be contacted for configuration policy information and/or information regarding updates to retrieved policy information. Included in the information can be a request for device identity information, path information, or other pertinent information relating to the industrial device and/or security environment. At 1216, a determination is made whether a security authority is found, and, if found (“YES”), a policy is obtained from the authority, at 1218. This policy can be applied to the device, at 1220.

If a security authority was not found, at 1216, (“NO”), a determination is made, at 1222 whether a stored policy is available. This programmed policy information can be information programmed into the device by a designer or other device programmer (e.g., factory settings). If a stored programmed policy is available (“YES”), a security authority can be checked to determine if updated security information is available. The stored and/or updated programmed policy is applied to the device at 1220. If a policy is not available (“NO”), or after the policy is applied, at 1220, the method continues at 1224 where programmed policy information internal to the device is applied.

According to some embodiments, method 1200 can support manual configuration options, such as user-configurable parameters. For example, a manual configuration may be that the device should not accept any information except information downloaded or received from a local device. In some embodiments, the manual configuration can be that the auto configuration policy can be loaded from a remote device that is not physically located near the device. It should be understood that these are merely examples, and other automatic configurations and/or manual configurations are possible with the disclosed embodiments.

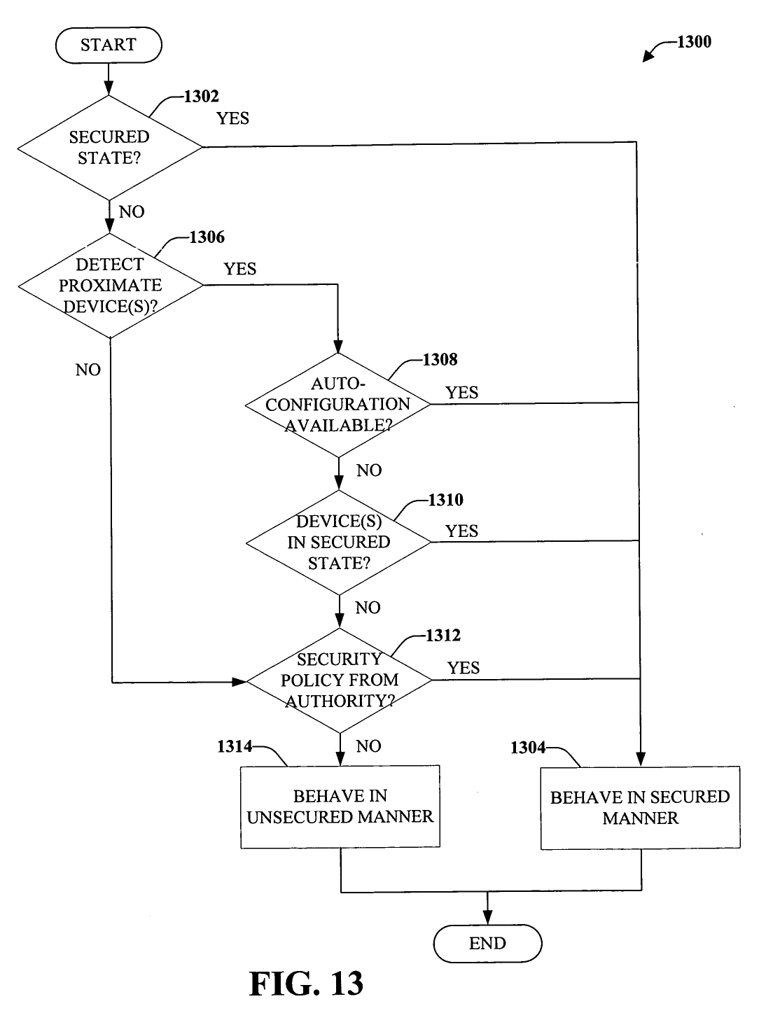

FIG. 13 illustrates a methodology 1300 for a device to determine whether to behave in a secured or an unsecured manner. If a device is in a secured environment, it should behave in a secured manner and, if the device is in an unsecured environment, it should behave in an unsecured manner. At 1302, a determination is made whether the device is in a secured state. This determination can be made based upon reviewing internal policies. If it is determined that the device is in a secured state (“YES”), the method continues, at 1304, and the device behaves in a secured manner.

If the determination, at 1302, is that the device is not in a secured sate (“NO”), the method continues, at 1306, where it is ascertained whether proximate device(s) are detected. The proximate devices can be proximate devices located near or proximate to the industrial device or they may be devices connected to industrial device. For example, the neighbors or proximate devices can be a slot on the industrial device backplane, MAC address on ControlNet, fixed name lookup, EtherNet/IP (e.g., Subnet, Multicast), or other devices. If no proximate device(s) are detected (“NO”), the method continues at 1312, which will be discussed below.

If one or more proximate device is detected, at 1306, (“YES”) a determination is made, at 1308, whether auto-configuration is available from the proximate device. If it is available, the method continues, at 1304, and the device behaves in a secured manner. If auto-configuration is not available (“NO”), the state of the proximate device(s) is evaluated to determine if the one or more proximate device is in a secured state. If one or more proximate device is in a secured state (“YES”) the method continues, at 1304, and the device behaves in a secured manner.

If there is not at least one proximate device in a secured state (“NO”), at 1312 it is determined whether there is a security policy available from a security authority. If no specific policies exist for the particular device, the security authority or server can provide a policy based on the class of device. If a security policy is available (“YES”), the method continues, at 1304, and the device behaves in a secured manner. If there is no security policy available from a security authority (“NO”), the method continues, at 1314, and the device behaves in an unsecured manner. To behave in an unsecured manner, the device should ignore its built-in security behaviors, if any. This includes the situation where there is no authority and/or no location information is available from the proximate device(s) to contact that authority. It is also possible that the security authority exists, buts its current policy setting is for the device to behave as though it is in an unsecured state. According to some embodiments, it is also possible for the environment to be secured, but the security authority is currently missing.

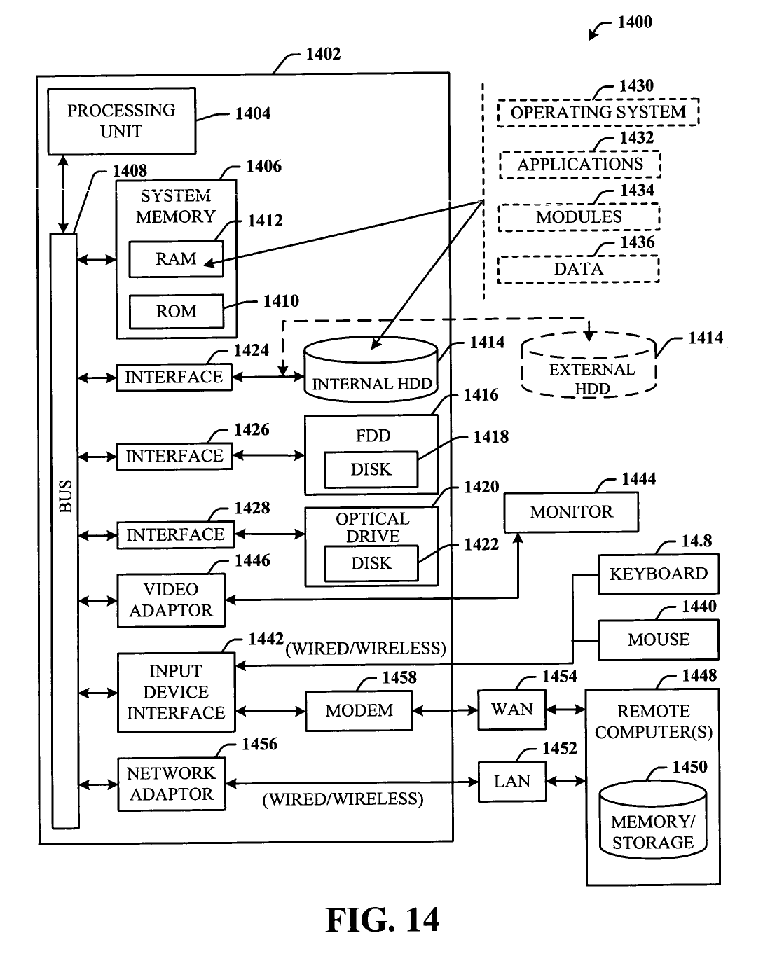

Referring now to FIG. 14, there is illustrated a block diagram of a computer operable to execute the disclosed architecture. In order to provide additional context for various aspects disclosed herein, FIG. 14 and the following discussion are intended to provide a brief, general description of a suitable computing environment 1400 in which the various aspects can be implemented. While the one or more embodiments have been described above in the general context of computer-executable instructions that may run on one or more computers, those skilled in the art will recognize that the various embodiments also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 14, the exemplary environment 1400 for implementing various aspects includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures may also be employed as the processing unit 1404.

The system bus 1408 can be any of several types of bus structure that may further interconnect to a memory bus (with or without a memory controller), a peripheral bus, and a local bus using any of a variety of commercially available bus architectures. The system memory 1406 includes read-only memory (ROM) 1410 and random access memory (RAM) 1412. A basic input/output system (BIOS) is stored in a non-volatile memory 1410 such as ROM, EPROM, or EEPROM, which BIOS contains the basic routines that help to transfer information between elements within the computer 1402, such as during start-up. The RAM 1412 can also include a high-speed RAM such as static RAM for caching data.

The computer 1402 further includes an internal hard disk drive (HDD) 1414 (e.g., EIDE, SATA), which internal hard disk drive 1414 may also be configured for external use in a suitable chassis (not shown), a magnetic floppy disk drive (FDD) 1416, (e.g., to read from or write to a removable diskette 1418) and an optical disk drive 1420, (e.g., reading a CD-ROM disk 1422 or, to read from or write to other high capacity optical media such as the DVD). The hard disk drive 1414, magnetic disk drive 1416 and optical disk drive 1420 can be connected to the system bus 1408 by a hard disk drive interface 1424, a magnetic disk drive interface 1426 and an optical drive interface 1428, respectively. The interface 1424 for external drive implementations includes at least one or both of Universal Serial Bus (USB) and IEEE 1494 interface technologies. Other external drive connection technologies are within contemplation of the one or more embodiments.

The drives and their associated computer-readable media provide nonvolatile storage of data, data structures, computer-executable instructions, and so forth. For the computer 1402, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods disclosed herein.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. It is appreciated that the various embodiments can be implemented with various commercially available operating systems or combinations of operating systems.

A user can enter commands and information into the computer 1402 through one or more wired/wireless input devices, e.g., a keyboard 1438 and a pointing device, such as a mouse 1440. Other input devices (not shown) may include a microphone, an IR remote control, a joystick, a game pad, a stylus pen, touch screen, or the like. These and other input devices are often connected to the processing unit 1404 through an input device interface 1442 that is coupled to the system bus 1408, but can be connected by other interfaces, such as a parallel port, an IEEE 1494 serial port, a game port, a USB port, an IR interface, etc.

A monitor 1444 or other type of display device is also connected to the system bus 1408 via an interface, such as a video adapter 1446. In addition to the monitor 1444, a computer typically includes other peripheral output devices (not shown), such as speakers, printers, etc.

The computer 1402 may operate in a networked environment using logical connections via wired and/or wireless communications to one or more remote computers, such as a remote computer(s) 1448. The remote computer(s) 1448 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1450 is illustrated. The logical connections depicted include wired/wireless connectivity to a local area network (LAN) 1452 and/or larger networks, e.g., a wide area network (WAN) 1454. Such LAN and WAN networking environments are commonplace in offices and companies, and facilitate enterprise-wide computer networks, such as intranets, all of which may connect to a global communications network, e.g., the Internet.

When used in a LAN networking environment, the computer 1402 is connected to the local network 1452 through a wired and/or wireless communication network interface or adapter 1456. The adaptor 1456 may facilitate wired or wireless communication to the LAN 1452, which may also include a wireless access point disposed thereon for communicating with the wireless adaptor 1456.

When used in a WAN networking environment, the computer 1402 can include a modem 1458, or is connected to a communications server on the WAN 1454, or has other means for establishing communications over the WAN 1454, such as by way of the Internet. The modem 1458, which can be internal or external and a wired or wireless device, is connected to the system bus 1408 via the serial port interface 1442. In a networked environment, program modules depicted relative to the computer 1402, or portions thereof, can be stored in the remote memory/storage device 1450. It will be appreciated that the network connections shown are exemplary and other means of establishing a communications link between the computers can be used.

The computer 1402 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10 BaseT wired Ethernet networks used in many offices.

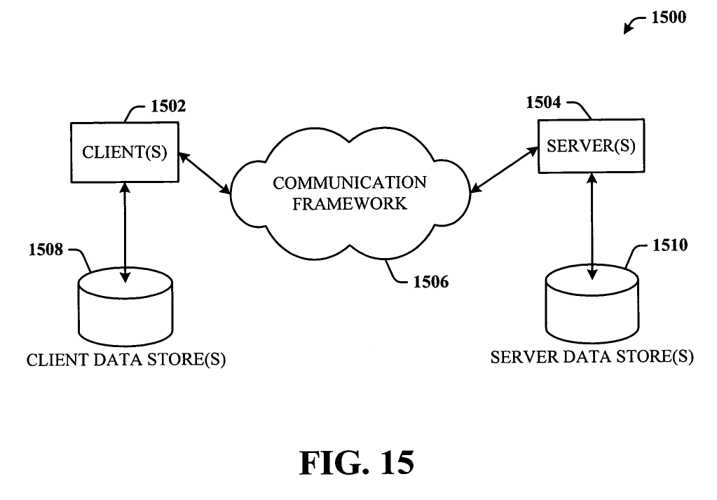

Referring now to FIG. 15, there is illustrated a schematic block diagram of an exemplary computing environment 1500 in accordance with the various embodiments. The system 1500 includes one or more client(s) 1502. The client(s) 1502 can be hardware and/or software (e.g., threads, processes, computing devices). The client(s) 1502 can house cookie(s) and/or associated contextual information by employing the various embodiments, for example.

The system 1500 also includes one or more server(s) 1504. The server(s) 1504 can also be hardware and/or software (e.g., threads, processes, computing devices). The servers 1504 can house threads to perform transformations by employing the various embodiments, for example. One possible communication between a client 1502 and a server 1504 can be in the form of a data packet adapted to be transmitted between two or more computer processes. The data packet may include a cookie and/or associated contextual information, for example. The system 1500 includes a communication framework 1506 (e.g., a global communication network such as the Internet) that can be employed to facilitate communications between the client(s) 1502 and the server(s) 1504.

Communications can be facilitated via a wired (including optical fiber) and/or wireless technology. The client(s) 1502 are operatively connected to one or more client data store(s) 1508 that can be employed to store information local to the client(s) 1502 (e.g., cookie(s) and/or associated contextual information). Similarly, the server(s) 1504 are operatively connected to one or more server data store(s) 1510 that can be employed to store information local to the servers 1504.

What has been described above includes examples of the various embodiments. It is, of course, not possible to describe every conceivable combination of components or methodologies for purposes of describing the various embodiments, but one of ordinary skill in the art may recognize that many further combinations and permutations are possible. Accordingly, the subject specification intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the various aspects include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

1. A system that automatically detects an environment type, comprising:
an analysis component that analyzes an environment of an industrial device;
a policy component that obtains a policy; and
a configuration component that configures the industrial device based in part on the obtained policy.

2. The system of claim 1, the policy component obtains the policy from one of an internal storage, a proximate device, and a security authority.

3. The system of claim 1, the configuration component configures the industrial device based on a programmed policy if the analyzed environment is a secured environment and the policy component is unable to obtain the policy.

4. The system of claim 1, the analysis component automatically analyzes the environment if an internal policy is not found.

5. The system of claim 1, the obtained policy is maintained in a storage media associated with the industrial device.

6. The system of claim 1, further comprising:
a search module that searches for proximate devices; and
a query module that requests information from the proximate devices that can be utilized to contact the security authority.

7. The system of claim 1, supports one of a secured-by-default mode and an open-by default mode based in part on the environment.

8. The system of claim 1, the policy component comprising:
a device identification module that sends device identity information to the security authority; and
a location module that provides location information to the security authority.

9. The system of claim 1, further comprising:
an automatic functionality that automatically configures the industrial device according to the environment; and
a manual functionality that receives and applies a manual change to the industrial device configuration.

10. The system of claim 1, the configuration component supports a product specific device hardening.

11. The system of claim 1, the analysis component employs one of an artificial intelligence component or a rules-based logic component to detect an environment and obtain environment policies.

12. A method for environment detection and industrial device configuration; comprising:
searching for policies internal to an industrial device;
analyzing an external environment to determine if the industrial device is located in a secured environment or an unsecured environment; and
applying an appropriate security action based in part on the external environment.

13. The method of claim 12, taking appropriate security action comprising:
obtaining an auto configuration policy if the device is in a secured environment and a security server is present; and
configuring the device to conform to the auto configuration policy.

14. The method of claim 12, further comprising applying an internal programmed policy if the external environment is a security environment and no polices are obtained from one of a security authority and a proximate device.

15. The method of claim 12, taking appropriate security action comprising maintaining the device in an unsecured mode if the external environment is unsecured.

16. The method of claim 12, analyzing an external environment further comprising:
locating a proximate device;
querying the proximate device for a security object; and
contacting a security authority based on the security object.

17. The method of claim 12, further comprising maintaining a security policy in a retrievable format.

18. The method of claim 17, further comprising automatically retrieving a security policy upon device power-up.

19. The method of claim 12, analyzing an external environment further comprising:
locating a proximate device that includes a duplicate security policy of the industrial device;
receiving the duplicate security policy from the proximate device; and
checking for updated security information from a security authority.

20. A system that provides auto-detection capabilities, comprising:
means for searching internally for a policy;
means for detecting an external environment type;
means for automatically conforming to the internal policy or the external environment type.

21. The system of claim 20, further comprising:
means for identifying at least one neighboring device;
means for querying the neighboring device for information; and
means for utilizing the information to contact a security authority.

22. The system of claim 20, further comprising means for selectively tailoring the automatic conformance to the internal policy or the external environment type.

23. The system of claim 20, further comprising:
means for supporting an open-by-default mode; and
means for supporting a secured-by-default mode.
